(19) United States
(12) Patent Application Publication
(10) Pub. No.: US 2014/0204924 A1
(43) Pub. Date: Jul. 24, 2014

(54) METHOD AND APPARATUS OF PERFORMING A DISCOVERY PROCEDURE

(71) Applicant: LG ELECTRONICS INC., Seoul (KR)

(72) Inventors: Kiseon RYU, Anyang-si (KR); Sanggook KIM, Anyang-si (KR); Kidong LEE, Anyang-si (KR)

(73) Assignee: LG ELECTRONICS INC., Seoul (KR)

(21) Appl. No.: 14/060,307

(22) Filed: Oct. 22, 2013

Related U.S. Application Data
(60) Provisional application No. 61/755,403, filed on Jan. 22, 2013.

(51) Int. Cl. H04W 40/24

(52) U.S. Cl. CPC H04W 40/246
USPC 370/338

(57) ABSTRACT

The present invention is directed to a method and an apparatus for use in a wireless communication system. Specifically, the present invention is directed to a method of performing a discovery procedure for a ProSe and an apparatus therefore, in which the method comprises: scanning one or more Wireless Local Area Network Access Points (WLAN APs); transmitting a scan result for the one or more WLAN APs to a cellular network entity; and initiating the discovery procedure for the ProSe, if the discovery procedure for the ProSe is allowed by the cellular network entity as a response to the scan result.

### TECHNICAL FIELD

The present invention is directed to a method and an apparatus for use in a wireless communication system. Specifically, the present invention is directed to a method and an apparatus of performing a discovery procedure.

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system and the like.

### DISCLOSURE

### Technical Problem

An object of the present invention is to provide a method and an apparatus of efficiently performing a discovery procedure.

It will be appreciated by persons skilled in the art that the objects that can be achieved through the present invention are not limited to what has been particularly described hereinabove and the above and other objects that the present invention can achieve will be more clearly understood from the following detailed description taken in conjunction with the accompanying drawings.

### Technical Solution

As a first aspect of the invention, a method of performing a discovery procedure for a Proximity-based Service (ProSe) by a User Equipment (UE) in a cellular communication system is provided, the method comprising: scanning one or more Wireless Local Area Network Access Points (WLAN APs); transmitting a scan result for the one or more WLAN APs to a cellular network entity; and initiating the discovery procedure for the ProSe, if the discovery procedure for the ProSe is allowed by the cellular network entity as a response to the scan result.

Preferably, the cellular network entity may include a 3rd Generation Partner Project (3GPP) network entity.

Preferably, the 3GPP network entity may include an evolved Node B (eNB), a Mobility Management Entity (MME) or a ProSe controller.

Preferably, the scan result may include a list of identification information for detected WLAN APs, wherein the identification information includes at least one of a Service Set Identification (SSID), a Basic Service Set Identification (BSSID) and a Medium Access Control (MAC) address.

Preferably, the scan result may further include a list of signal strengths of the detected WLNA APs.

Preferably, the discovery procedure for the ProSe may be allowed if the UE receives, from the cellular network entity, information indicating existence of another UE in proximity.

As a second aspect of the invention, a method of performing a discovery procedure for a Proximity-based Service (ProSe) by a cellular network entity in a cellular communication system is provided, in which the method comprising: receiving a first scan result for one or more first Wireless Local Area Network Access Points (WLAN APs) from a first User Equipment (UE); receiving a second scan result for one or more second WLAN APs from a second UE; and if there is one or more common WLAN APs between the one or more first WLAN APs and the one or more second WLAN APs, allowing the discovery procedure for the ProSe to at least one of the first UE and the second UE.

Preferably, the cellular network entity may include a 3rd Generation Partner Project (3GPP) network entity.

Preferably, the 3GPP network entity may include an evolved Node B (eNB), a Mobility Management Entity (MME) or a ProSe controller.

Preferably, the first and second scan results may include a list of identification information for detected WLAN APs, wherein the identification information includes at least one of a Service Set Identification (SSID), a Basic Service Set Identification (BSSID) and a Medium Access Control (MAC) address.

Preferably, the first and second scan results may further include a list of signal strengths of the detected WLNA APs.

Preferably, the allowing the discovery procedure for the ProSe may include transmitting information indicating existence of another UE in proximity.

As a third aspect of the invention, a User Equipment (UE) configured to perform a discovery procedure for a Proximity-based Service (ProSe) in a wireless communication system is provided, in which the UE comprising: a radio frequency (RF) unit; and a processor, wherein the processor is configured: to scan one or more Wireless Local Area Network Access Points (WLAN APs), to transmit a scan result for the one or more WLAN APs to a cellular network entity, and to initiate the discovery procedure for the ProSe, if the discovery procedure for the ProSe is allowed by the cellular network entity as a response to the scan result.

Preferably, the cellular network entity may include a 3rd Generation Partner Project (3GPP) network entity.

Preferably, the 3GPP network entity may include an evolved Node B (eNB), a Mobility Management Entity (MME) or a ProSe controller.

Preferably, the scan result may include a list of identification information for detected WLAN APs, wherein the identification information includes at least one of a Service Set Identification (SSID), a Basic Service Set Identification (BSSID) and a Medium Access Control (MAC) address.

Preferably, the scan result may further include a list of signal strengths of the detected WLNA APs.

Preferably, the discovery procedure for the ProSe may be allowed if the UE receives, from the cellular network entity, information indicating existence of another UE in proximity.

As a fourth aspect of the invention, a cellular network entity configured to perform a discovery procedure for a Proximity-based Service (ProSe) in a wireless communication system is provided, in which the cellular network entity comprising: a radio frequency (RF) unit; and a processor, wherein the processor is configured: to receive a first scan result for one or more first Wireless Local Area Network Access Points (WLAN APs) from a first User Equipment (UE), to receive a second scan result for one or more second WLAN APs from a second UE, and if there is one or more common WLAN APs between the one or more first WLAN APs and the one or more second WLAN APs, to allow the discovery procedure for the ProSe to at least one of the first UE and the second UE.

Preferably, the cellular network entity may include a 3rd Generation Partner Project (3GPP) network entity.

Preferably, the 3GPP network entity may include an evolved Node B (eNB), a Mobility Management Entity (MME) or a ProSe controller.

Preferably, the first and second scan results may include a list of identification information for detected WLAN APs, wherein the identification information includes at least one of a Service Set Identification (SSID), a Basic Service Set Identification (BSSID) and a Medium Access Control (MAC) address.

Preferably, the first and second scan results may further include a list of signal strengths of the detected WLNA APs.

Preferably, the allowing the discovery procedure for the ProSe may include transmitting information indicating existence of another UE in proximity.

### Advantageous Effects

Exemplary embodiments of the present invention have the following effects. In accordance with the embodiments of the present invention, efficient discovery procedure is provided.

It will be appreciated by persons skilled in the art that the effects that can be achieved through the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 illustrates a network structure of an Evolved Universal Mobile Telecommunication System (E-UMTS).

FIG. 2 illustrates a general structure of a typical E-UTRAN and that of a typical Evolved Packet Core (EPC).

FIGS. 3a˜3b illustrate a user-plane protocol and a control-plane protocol stack for the E-UMTS network

FIG. 4 illustrates a downlink subframe and physical channels.

FIG. 5 illustrates a contention-based Random Access (RA) procedure.

FIG. 6 illustrates an example of default data path for a normal communication.

FIGS. 7˜8 illustrate examples of data path scenarios for a proximity communication.

FIGS. 9˜10 show examples of performing Cell-based ProSe UE discovery in accordance with the present invention.

FIG. 11 shows another example of performing Cell-based ProSe UE discovery in accordance with the present invention.

FIG. 12 shows an example of performing WLAN AP-based ProSe UE discovery in accordance with the present invention.

FIG. 13 illustrates a block diagram of a UE or Mobile Station (MS).

### MODE FOR INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following embodiments of the present invention can be applied to a variety of wireless access technologies, for example, CDMA, FDMA, TDMA, OFDMA, SC-FDMA, MC-FDMA, and the like. CDMA can be implemented by wireless communication technologies, such as Universal Terrestrial Radio Access (UTRA) or CDMA2000. TDMA can be implemented by wireless communication technologies, for example, Global System for Mobile communications (GSM), General Packet Radio Service (GPRS), Enhanced Data rates for GSM Evolution (EDGE), etc. OFDMA can be implemented by wireless communication technologies, for example, IEEE 802.11 (Wi-Fi), IEEE 802.16 (WiMAX), IEEE 802.20, E-UTRA (Evolved UTRA), and the like. UTRA is a part of the Universal Mobile Telecommunications System (UMTS). 3rd Generation Partnership Project (3GPP) Long Term Evolution (LTE) is a part of Evolved UMTS (E-UMTS) that uses E-UTRA. The LTE-Advanced (LTE-A) is an evolved version of 3GPP LTE. Although the following embodiments of the present invention will hereinafter describe inventive technical characteristics on the basis of the 3GPP LTE/LTE-A system, it should be noted that the following embodiments will be disclosed only for illustrative purposes and the scope and spirit of the present invention are not limited thereto.

Although the following embodiments of the present invention will hereinafter describe inventive technical characteristics on the basis of the 3GPP LTE/LTE-A system, it should be noted that the following embodiments will be disclosed only for illustrative purposes and the scope and spirit of the present invention are not limited thereto. Specific terms used for the exemplary embodiments of the present invention are provided to aid in understanding of the present invention. These specific terms may be replaced with other terms within the scope and spirit of the present invention.

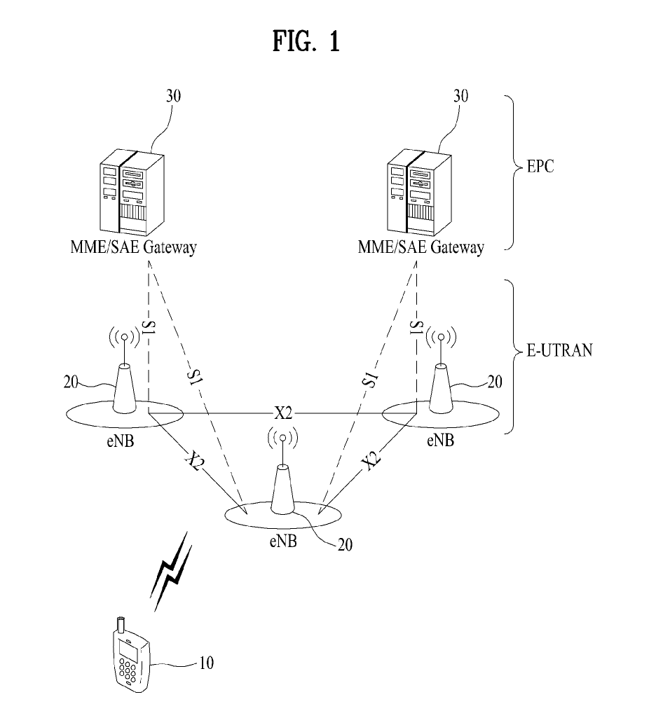

FIG. 1 illustrates a network structure of an E-UMTS. The E-UMTS may be also referred to as an LTE system. The E-UMTS is widely deployed to provide a variety of communication services such as voice and packet data, and is generally configured to function based upon the various techniques presented herein and discussed in more detail with regard to later figures.

With reference to FIG. 1, the E-UMTS network includes an Evolved UMTS Terrestrial Radio Access Network (E-UTRAN), an Evolved Packet Core (EPC), and one or more mobile terminals (or User Equipment (UE)) 10. The E-UTRAN includes one or more eNodeBs (eNBs) 20. Regarding the EPC, Mobility Management Entity/System Architecture Evolution (MME/SAE) gateway 30 provides an end point of a session and mobility management function for the UE 10. The eNB 20 and the MME/SAE gateway 30 may be connected via an S1 interface.

The UE 10 is a communication device carried by a user and may also be referred to as a Mobile Station (MS), a User Terminal (UT), a Subscriber Station (SS) or a wireless device. In general, the UE includes a transmitter and processor, among other components, and is configured to operate in accordance with the various techniques presented herein.

The eNB 20 is generally a fixed station that communicates with the UE 10. In addition to being referred to as a base station, the eNB 20 may also be referred to as an access point. An eNB 20 provides end points of a user plane and a control plane to the UE 10. In general, the eNB includes a transmitter and processor, among other components, and is configured to operate in accordance with the various techniques presented herein.

A plurality of UEs 10 may be located in one cell. One eNB 20 is typically deployed per cell. An interface for transmitting user traffic or control traffic may be used between eNBs 20. Here, “downLink (DL)” refers to communication from the eNB 20 to the UE 10, and “UpLink (UL)” refers to communication from the UE to the eNB.

The MME gateway 30 provides various functions including distribution of paging messages to eNBs 20, security control, idle state mobility control, SAE bearer control, and ciphering and integrity protection of Non-Access Stratum (NAS) signaling. The SAE gateway 30 provides assorted functions including termination of U-plane packets for paging reasons, and switching of the U-plane to support UE mobility.

A plurality of nodes may be connected between eNB 20 and gateway 30 via the S1 interface. The eNBs 20 may be connected to each other via an X2 interface and neighboring eNBs may have a meshed network structure that has the X2 interface.

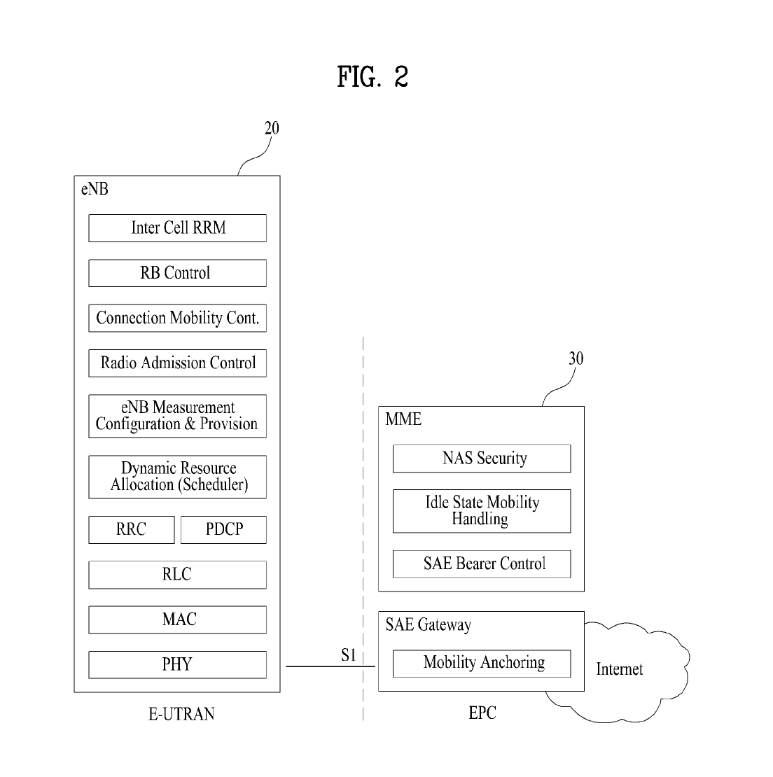

FIG. 2 is a block diagram depicting general structures of an E-UTRAN and an EPC. With reference to FIG. 2, eNB 20 may perform functions of selection for MME/SAE gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, Radio Admission Control (RAC), and connection mobility control in LTE_ACTIVE state.

In the EPC, and as described above, MME/SAE gateway 30 may perform functions of paging origination, LTE-IDLE state management, ciphering of the user plane, SAE bearer control, and ciphering and integrity protection of NAS signaling.

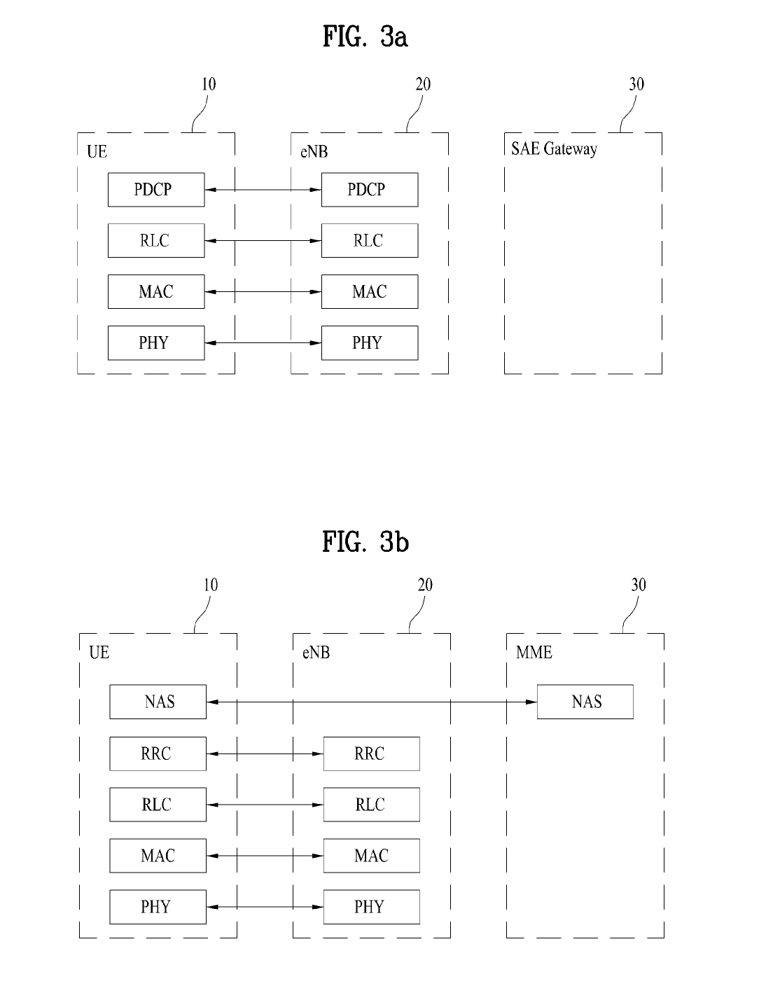

FIGS. 3a˜3b illustrate the user-plane protocol and the control-plane protocol stack for the E-UMTS network. With reference to FIGS. 3a˜3b, the protocol layers may be divided into a first layer (L1), a second layer (L2) and a third layer (L3) based upon the three lower layers of an Open System Interconnection (OSI) standard model as known in the art of communication systems.

The first layer L1 (or the physical layer) provides an information transmission service to an upper layer using a physical channel. The physical layer is connected with a Medium Access Control (MAC) layer through a transport channel, and data between the MAC layer and the physical layer are transferred via the transport channel. Between different physical layers, namely, between physical layers of a transmission side and a reception side (for example, between physical layers of UE 10 and eNB 20), data are transferred via the physical channel.

The MAC layer of Layer 2 (L2) provides services to a Radio Link Control (RLC) layer via a logical channel. The RLC layer of Layer 2 (L2) supports a reliable transmission of data. Although the RLC layer is shown in FIGS. 3a˜3b as being separate from the MAC layer, it is understood that the functions of the RLC layer may be performed by the MAC layer and that, therefore, a separate RLC layer is not required. With reference to FIG. 3a, the Packet Data Convergence Protocol (PDCP) layer of Layer 2 (L2) performs a header compression function that reduces unnecessary control information such that data being transmitted by employing Internet Protocol (IP) packets, such as IPv4 or IPv6, can be efficiently sent over a radio (wireless) interface that has a relatively narrow bandwidth.

With reference to FIG. 3b, a Radio Resource Control (RRC) layer located at the lowest portion of the third layer (L3) is typically only defined in the control plane and controls logical channels, transport channels and the physical channels in relation to the configuration, reconfiguration, and release of the Radio Bearers (RBs). Here, the RB means a service provided by the second layer (L2) for data transmission between the terminal and the E-UTRAN.

With reference to FIG. 3a, the RLC and MAC layers (terminated in an eNB 20 on the network side) may perform functions such as Scheduling, Automatic Repeat reQuest (ARQ), and Hybrid Automatic Repeat reQuest (HARQ). The PDCP layer (terminated in eNB 20 on the network side) may perform the user plane functions such as header compression, integrity protection, and ciphering.

With reference to FIG. 3b, the RLC and MAC layers (terminated in an eNB 20 on the network side) perform the same or similar functions as for the control plane. The RRC layer (terminated in an eNB 20 on the network side) may perform functions such as broadcasting, paging, RRC connection management, RB control, mobility functions, and UE measurement reporting and controlling. The NAS control protocol (terminated in the MME 30 on the network side) may perform functions such as a SAE bearer management, authentication, LTE_IDLE mobility handling, paging origination in LTE_IDLE, and security control for the signaling between the gateway and UE 10.

The NAS control protocol may use three different states: first, a LTE_DETACHED state if there is no RRC entity; second, a LTE_IDLE state if there is no RRC connection while storing minimal UE information; and third, an LTE_ACTIVE state if the RRC connection is established.

Thus RRC state may be divided into two different states such as an RRC_IDLE state and an RRC_CONNECTED state. In the RRC_IDLE state, the UE 10 may receive broadcasts of system information and paging information while the UE specifies a Discontinuous Reception (DRX) configured by NAS, and the UE has been allocated an identification (ID) (e.g., System Architecture Evolution-Temporary Mobile Subscriber Identity (S-TMSI)) which uniquely identifies the UE in a tracking area. Also, in the RRC-IDLE state, no RRC context is stored in the eNB.

In the RRC_IDLE state, the UE 10 specifies the paging DRX (Discontinuous Reception) cycle. Specifically, the UE 10 monitors a paging signal at a specific paging occasion of every UE specific paging DRX cycle.

In the RRC_CONNECTED state, the UE 10 has an E-UTRAN RRC connection and a RRC context is stored in the E-UTRAN, such that transmitting and/or receiving data to/from the network (eNB) becomes possible. Also, the UE 10 can report channel quality information and feedback information to the eNB.

In RRC_CONNECTED state, the E-UTRAN knows the cell to which the UE 10 belongs. Therefore, the network can transmit and/or receive data to/from UE 10, and the network can control mobility (handover) of the UE.

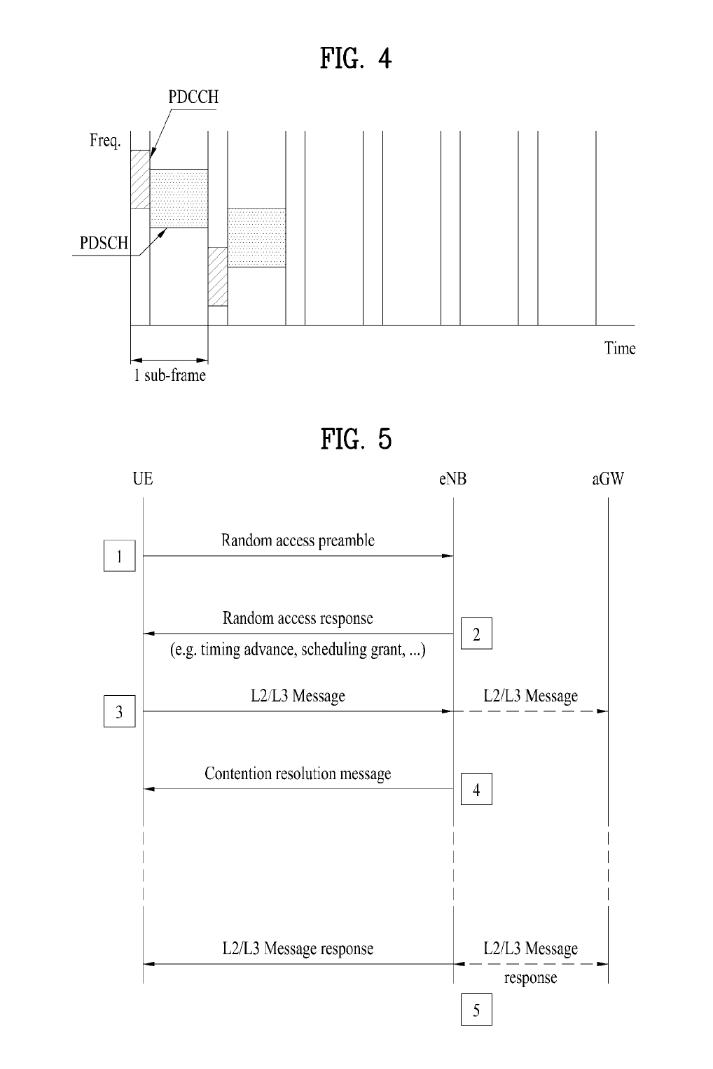

FIG. 4 illustrates a downlink subframe and physical channels.

With reference to FIG. 4, the downlink subframe includes a plurality of slots (e.g., two). The number of OFDM symbols included in one slot may be changed according to the length of a Cyclic Prefix (CP). For example, in case of a normal CP, the slot may include seven OFDM symbols. The downlink subframe is divided into a data region and a control region in a time domain. A maximum of three (or four) OFDM symbols located in the front part of a first slot of the subframe may correspond to a control region to which a control channel is allocated. The remaining OFDM symbols correspond to a data region to which a Physical Downlink Shared Channel (PDSCH) is allocated. A variety of downlink control channels may be used in LTE(-A), for example, a Physical Control Format Indicator Channel (PCFICH), a Physical Downlink Control Channel (PDCCH), a Physical hybrid ARQ indicator Channel (PHICH), etc. The PCFICH is transmitted on the first OFDM symbol of the subframe, and carries information about the number of OFDM symbols used for transmitting control channels within the subframe. The PHICH carries a Hybrid Automatic Repeat reQuest Acknowledgment/Negative-Acknowledgment (HARQ ACK/NACK) signal as a response to an uplink transmission signal.

Control information transmitted over a PDCCH is referred to as Downlink Control Information (DCI). DCI includes resource allocation information for either a UE or a UE group and other control information. For example, DCI includes UL/DL scheduling information, an UL transmission (Tx) power control command, etc.

The PDCCH carries a variety of information, for example, transmission format and resource allocation information of a DownLink Shared Channel (DL-SCH), transmission format and resource allocation information of an UpLink Shared Channel (UL-SCH), paging information transmitted over a Paging Channel (PCH), system information transmitted over the DL-SCH, resource allocation information of an upper-layer control message such as a random access response transmitted over PDSCH, a set of Tx power control commands of each UE contained in a UE group, a Tx power control command, activation indication information of Voice over IP (VoIP), and the like. A plurality of PDCCHs may be transmitted within a control region. A UE can monitor a plurality of PDCCHs. A PDCCH is transmitted as an aggregate of one or more contiguous Control Channel Elements (CCEs). The CCE is a logical allocation unit that is used to provide a coding rate based on a radio channel state to a PDCCH. The CCE may correspond to a plurality of Resource Element Groups (REGs). The format of PDCCH and the number of PDCCH bits may be determined according to the number of CCEs. A Base Station (BS) decides a PDCCH format according to DCI to be sent to the UE, and adds a Cyclic Redundancy Check (CRC) to control information. The CRC is masked with an identifier (e.g., Radio Network Temporary Identifier (RNTI)) according to a PDCCH owner or a purpose of the PDCCH. For example, provided that the PDCCH is provided for a specific UE, a CRC may be masked with an identifier of the corresponding UE (e.g., cell-RNTI (C-RNTI)). If PDCCH is provided for a paging message, a CRC may be masked with a paging identifier (e.g., Paging-RNTI (P-RNTI)). If a PDCCH is provided for system information (e.g., System Information Block (SIB)), a CRC may be masked with system Information RNTI (SI-RNTI). If PDCCH is provided for a random access response, a CRC may be masked with Random Access-RNTI (RA-RNTI). For example, CRC masking (or scrambling) may be performed using an exclusive OR (XOR) operation between CRC and RNTI at a bit level.

To initiate access to the network, a random access procedure is used. The random access procedure is also referred to as a Random Access Channel (RACH) procedure. Physical Random Access Channel (PRACH) transmission is under control of higher layer protocol which performs some important functions related to priority and load control. The PRACH is a common physical channel dedicated to the random access procedure. There are two kinds of RACH procedures: contention-based RACH procedure and non-contention-based RACH procedure. In the contention-based RACH procedure, many UEs can attempt to access the same base station simultaneously using same RACH preamble/resources, which may lead to network access congestions/collisions. Hereinafter, unless mentioned otherwise, a RACH (or RA) procedure means a contention-based RACH (or RA) procedure.

A RACH procedure can be used for several purposes. For example the RACH procedure can be used to access the network, to request resources, to carry control information, to adjust the time offset of the uplink in order to obtain uplink synchronization, to adjust the transmitted power, etc.

A RACH procedure can be initiated by the UE or the eNB. The RACH procedure may, for instance, be triggered by the following events:
A UE switches from power-off to power-on and needs to be registered to the network.
A UE is not time-synchronized with an eNB and starts transmitting data (for instance the user calls).
An eNB starts transmitting data to the UE but they are not synchronized (for instance the user receives a call).
An eNB measures a delay of the received signal from the UE (for instance the user is moving and has lost synchronization).

FIG. 5 illustrates a contention-based random access procedure.

With reference to FIG. 5, firstly the UE retrieves information transmitted periodically from eNB on a downlink Broadcast Channel (BCH) and selects a preamble signature (e.g., Constant Amplitude Zero Auto-Correlation (CAZAC) sequence), a RACH time slot and a frequency band. The preamble signature is chosen by the UE from among a set of signatures known by the eNB. The UE generates a random access preamble (message 1, box 1) containing the chosen signature and transmits it to the eNB over the selected time slot at the selected frequency. The random access preamble is sent before a RACH connection request and indicates that the UE is about to transmit data. During the random access procedure, several UEs may share the same RACH channel (i.e., PRACH) and they are distinguished by preamble signatures. Congestions/collisions occur whenever several UEs choose the same signature and send it within the same time and frequency resources.

The eNB monitors the current RACH slot in an attempt to detect preambles transmitted from UEs in a corresponding cell. On reception of a signal, the eNB correlates the received signal in the RACH subframe with all possible signatures. Detection of the preamble can be either performed in the time domain or in the frequency domain. A detection variable is computed for each signature. If the detection variable exceeds a certain threshold, the preamble is considered detected.

The eNB sends a random access response (message 2, box 2) to acknowledge the successfully detected preambles. The random access response is sent via a downlink shared channel and includes the detected signature. The random access response also contains a timing advance command, a power-control command.

If the UE receives a random access response from the eNB, the UE decodes the random access response and adapts UL transmission timing, and UL transmission power if the random access response contains power control information. The UE then sends a resource request message (message 3, box 3) via an uplink shared channel. In the message 3, the UE requests bandwidth and time resources to transmit data and it also indicates a UE-specific identifier.

When the UE requests resources, the UE uses a specific ID in the message 3 to resolve contentions. Then the UE monitors a specified downlink channel for response from the eNB. In the case of a positive resource grant, the subsequent transmissions are carried out as normal.

The eNB attempts to resolve any contentions. If the eNB receives a resource request with a UE-specific signature, the eNB checks how many UEs were detected with the same signature and resolves any possible contentions. If the preamble sent by a UE was in collision with a preamble from another UE, the eNB sends a contention resolution message (message 4, box 4) to command a corresponding UE to re-start the RACH procedure. If the UE was not in collision, the eNB sends a resource assignment message (message 5, box 5). Subsequent transmissions are carried out as usual.

Recently, Proximity-based Service (ProSe) has been discussed in 3GPP. The ProSe enables different UEs to be connected (directly) each other (after appropriate procedure(s), such as authentication), through eNB only (but not further through Serving Gateway (SGW)/Packet Data Network Gateway (PDN-GW, PGW)), or through SGW/PGW. Thus, using the ProSe, device to device direct communication can be provided, and it is expected that every devices will be connected with ubiquitous connectivity. Direct communication between devices in a near distance can lessen the load of network. Recently, proximity-based social network services have come to public attention, and new kinds of proximity-based applications can be emerged and may create new business market and revenue. For the first step, public safety and critical communication are required in the market. Group communication is also one of key components in the public safety system. Required functionalities are: Discovery based on proximity, Direct path communication, and Management of group communications.

Use cases and scenarios are for example:
Commercial/social use
Network offloading
Public Safety
Integration of current infrastructure services, to assure the consistency of the user experience including reachability and mobility aspects
Public Safety, in case of absence of EUTRAN coverage (subject to regional regulation and operator policy, and limited to specific public-safety designated frequency bands and terminals)

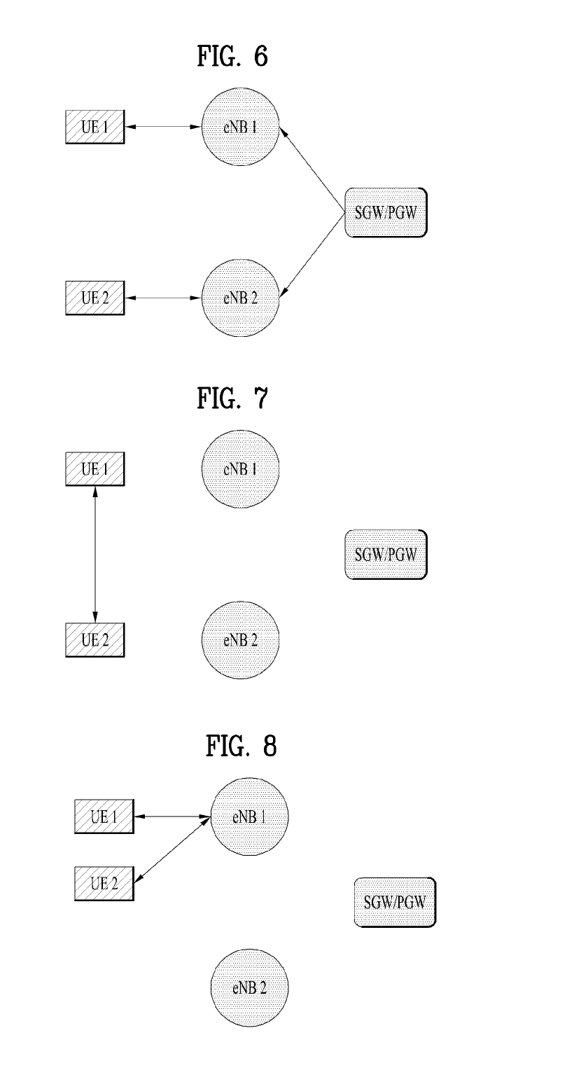

FIG. 6 illustrates an example of default data path for communication between two UEs. With reference to FIG. 6, even when two UEs (e.g., UE1, UE2) in close proximity communicate with each other, their data path (user plane) goes via the operator network. Thus a typical data path for the communication involves eNB(s) and/or Gateway(s) (GW(s)) (e.g., SGW/PGW).

FIGS. 7˜8 illustrate examples of data path scenarios for a proximity communication. If wireless devices (e.g., UE1, UE2) are in proximity of each other, they may be able to use a direct mode data path (FIG. 7) or a locally routed data path (FIG. 8). In the direct mode data path, wireless devices are connected directly each other (after appropriate procedure(s), such as authentication), without eNB and SGW/PGW. In the locally routed data path, wireless devices are connected each other through eNB only.

### Example

### Network-Assisted ProSe Discovery

In order to initiate ProSe communication, ProSe-enabled UEs firstly have to discover other ProSe-enabled UE in proximity (e.g., a crime scene, a fire scene). Two types of ProSe discovery defined: (i) Open ProSe Discovery means a ProSe Discovery without explicit permission from the UE being discovered, and (ii) Restricted ProSe Discovery means a ProSe Discovery that only takes place with explicit permission from the UE being discovered.

ProSe discovery procedure may be defined as follows:
UE (i.e., ProSe discovering UE) sends a predefined radio signal for ProSe discovery with/without a certain periodicity when it needs to initiate a ProSe communication path with other UE (i.e., ProSe discovered UE);
If ProSe discovered UE receives a predefined radio signal for ProSe discovery, it responds to the ProSe discovering UE; and
ProSe UEs negotiate their ProSe capability to establish the ProSe direct communication path between them

UE discovery requires: Radio resource reservation for transmission and reception of ProSe discovery signal (e.g., pilot signal, Synchronization signal) known to both a discovering UE and a discovered UE, and UEs' power consumption to send/monitor ProSe discovery signal.

To reduce UEs' power consumption and radio resource overhead, ProSe discovery signal is recommended, especially for Restricted ProSe Discovery, to be sent/monitored by ProSe UEs only when it is high probability that ProSe-enabled UEs are within their ProSe communication coverage. Thus, it is preferable, before sending ProSe discovery signal from a discovering UE to a UE to be discovered, the discovering UE checks if the UE to be discovered can be within a ProSe direct communication range.

For this, the present invention proposes a network assisted ProSe UE discovery mechanism such as:
Cell (i.e., coverage of eNB) based mechanism; and
WLAN AP (i.e., coverage of WLAN AP) based mechanism.

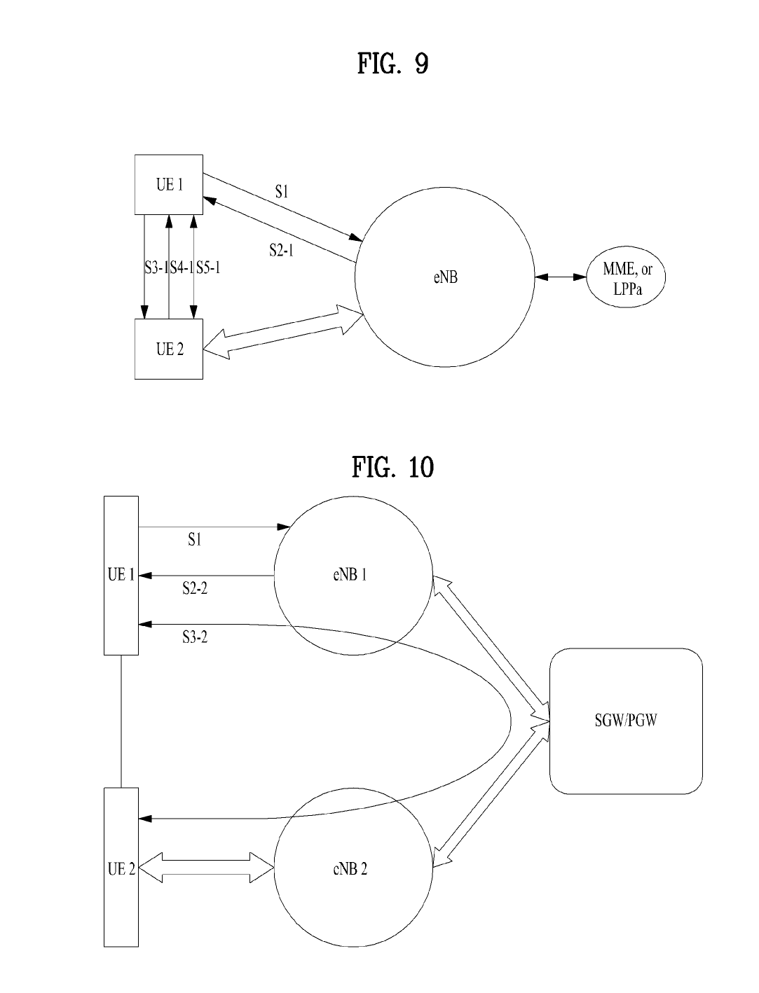

FIGS. 9˜10 show examples of performing Cell-based ProSe UE discovery in accordance with the present invention.

Referring to FIGS. 9˜10, once a ProSe communication is initiated, UE 1 (i.e., ProSe discovering UE) may send a signal (S1) that requests a network entity to check if UE 2 (i.e., ProSe discovered UE) to be discovered for ProSe communication is within the cell or not. Initiation of the ProSe communication can be triggered by a ProSe application. In 3GPP communication system, the network entity may be an evolved Node B (eNB), a Mobility Management Entity (MME), a LTE Positioning Protocol A (LPPa), a ProSe controller, and the like. In this case, ID of UE 2 (e.g., Internet Protocol (IP) Address, Medium Access Control (MAC) Address, Mobile Station International Subscriber Directory Number (MSISDN), or other UE ID assigned by service provider) may be included in the signal sent from UE 1 to the eNB.

Depending upon scenarios, two cases may be considered:
Case 1 (FIG. 9): If the UE 2 is within the coverage of the eNB,

The eNB may send a signal (S2-1) to indicate the UE 2's presence to UE 1. After receiving it, UE 1 may initiate the ProSe UE discovery procedure (based on device to device communication) by sending ProSe discovery signal (S3-1) to UE 2. For this, the eNB may assign a specific radio resource (e.g., time & frequency) to UE 1. In addition, the eNB may inform UE 2 of radio resource information assigned for the ProSe discovery signal transmission. After receiving the ProSe discovery signal (S3-1), UE 2 may transmit a response (S4-1) respond to UE 1. Then, UE 1 and UE 2 may establish a ProSe direct communication path (S5-1).
Case 2 (FIG. 10): If UE 2 is not within the coverage of the eNB,

The eNB may send a signal (S2-2) to indicate the UE 2's absence to UE 1. In this case, a ProSe UE discovery procedure based on device to device communication is not initiated. Instead, infrastructure data path (S3-2) is established between UE 1 and UE 2. For case 2, if eNB 2 is a neighbor eNB of eNB 1, the procedure of case 1 can be performed.

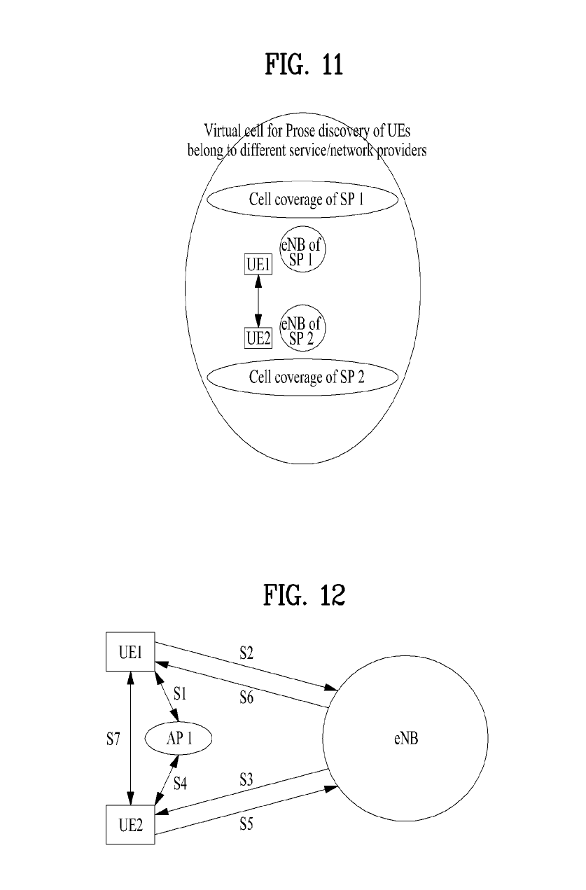

FIG. 11 shows another example of performing Cell-based ProSe UE discovery in accordance with the present invention. If UE 1 and UE 2 may be belong to different network service providers/Public Land Mobile Networks (PLMNs) each other, a virtual cell range for ProSe discovery can be defined among service providers. Here, the virtual cell is defined as an overlapped cell range among eNBs belonging to different network service providers. For this, proximity information of eNBs of other network service providers may be shared among network service providers, and a ProSe Controller may manage and update proximity information of eNBs belonging to one or more network service providers.

Referring to FIG. 11, it is assumed that UE 1 belongs to Service Provider 1 (SP 1), UE 2 belongs to Service Provider 2 (SP2), and UE 1 and UE 2 are within a coverage of a virtual cell, which they can establish a ProSe direct communication path. In this case, once a ProSe communication is initiated, UE 1 (here, ProSe discovering UE) may send a signal that requests the eNB to check if UE 2 (here, ProSe discovered UE) to be discovered for ProSe communication is within the virtual cell range or not. Initiation of the ProSe communication can be triggered by a ProSe application. If UE 2 is recognized being within the virtual cell range, the eNB may send a signal to indicate the UE 2's presence to UE 1. Before this, eNB can get, from a ProSe Controller, proximity information regarding whether UE 2 is within the virtual cell range of UE 1. After receiving the signal indicating the UE 2's presence, UE 1 may initiate a ProSe discovery procedure (based on device to device communication) by sending a ProSe discovery signal.

FIG. 12 shows an example of performing WLAN AP-based ProSe UE discovery in accordance with the present invention. This mechanism is to check if a ProSe discovering UE and a ProSe discovered UE are within the ProSe direct communication range by matching their detected WLAN AP. In particular, a network entity may receive WLAN AP scanning results from ProSe-enabled UEs which are about to establish a ProSe direct communication path. Then, if the network entity recognizes that a same AP is detected by the ProSe-enabled UEs, the network entity may request the ProSe-enabled UEs to initiate a ProSe discovery procedure based on device to device direct communication. In 3GPP communication system, the network entity may be an evolved Node B (eNB), a Mobility Management Entity (MME), a LTE Positioning Protocol A (LPPa), a ProSe controller, and the like.

Referring to FIG. 12, for a ProSe communication, UE 1 (here, ProSe discovering UE) may scan neighboring WLAN APs (S1), and may send a request that request a network entity (e.g., eNB) to check if UE 2 (here, ProSe discovered UE) to be discovered for ProSe communication is within the ProSe communication range (S2). In this case, the request (S2) may include ID of UE 2 (e.g., IP Address, MAC Address, MSISDN, or other UE ID assigned by service provider). The request (S2) may include WLAN AP scanning result if there is any WLAN AP detected by UE 1. Here, the WLAN AP scanning result may include for example a list of detected WLAN APs (e.g., AP's SSID, AP's BSSID—AP's MAC Address, etc.). In addition, the request (S2) may also include signal strength information for the detected WLAN AP(s). In this case, information about one or more WLAN AP whose signal strength is less than a threshold value may not be included in the request (S2), i.e., may be excluded from the WLAN AP scanning result and the signal strength information in the request (S2).

Meanwhile, UE 2 (here, ProSe discovered UE) may receive a signal (S3) from the network entity (e.g., eNB) that requests UE 2 to report WLAN AP scanning result. In accordance with the request (S3), UE 2 may scan neighboring WLAN APs (S4), and may send a response (S5) including WLAN AP scanning result to the network entity (e.g., eNB). The response (S5) may include ID of UE 2 (e.g., IP Address, MAC Address, MSISDN, or other UE ID assigned by service provider). The WLAN AP scanning result may be included in the response (S5) only if there is any WLAN AP detected by UE 2. The WLAN AP scanning result may include for example a list of detected WLAN APs (e.g., AP's SSID, AP's BSSID—AP's MAC Address, etc.). In addition, the WLAN AP scanning result may also include signal strength information for the detected WLAN AP(s). In this case, information about one or more WLAN AP whose signal strength is less than a threshold value may not be included in the response (S5), i.e., may be excluded from the WLAN AP scanning result and the signal strength information in the response (S5).

Upon receipt of the request (S2) and the response (S5), the network entity (e.g., eNB) may check if there is any matched WLAN AP among the list of detected WLAN APs reported by UE1 and UE2. Then, if there is any matched WLAN AP from the reported AP lists, signal strength information of WLAN APs can be considered as a criteria for UEs to initiate ProSe discovery procedure (based on device to device communication). For example, the criteria may be: for a WLAN AP, a sum of a signal strength reported by UE 1 and a signal strength reported by UE 2 is equal to or less than a threshold value. If there is at lease one WLAN AP satisfying the criteria, the eNB may send a signal indicating UE 2's presence to UE 1 (S6). After receiving the signal (S6), UE 1 may initiate ProSe discovery procedure (based on device to device communication) by sending a ProSe discovery signal (S7).

Alternatively, UEs may first check if they are served by the same eNB, then if yes, UEs scan WLAN AP and check if they detect any same AP. In this case, if two conditions are met, UEs may initiate device to device based ProSe discovery procedure.

Here, UE 1 and UE 2 may or may not be connected by the same eNB even though they detect the same AP. In addition, the proposed WLAN based mechanism can be used as a standalone method. In addition, the proposed WLAN based mechanism can also be used as a complementary method in addition to Cell based mechanism.

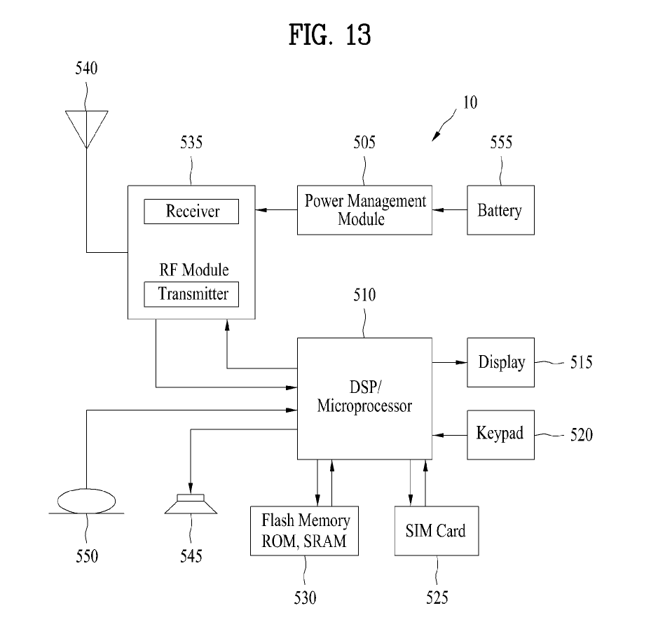

FIG. 13 illustrates a block diagram of a UE or Mobile Station (MS) 10. The UE 10 includes a MTC device or a delay-tolerant device. The UE 10 includes a processor (or digital signal processor) 510, RF module 535, power management module 505, antenna 540, battery 555, display 515, keypad 520, memory 530, SIM card 525 (which may be optional), speaker 545 and microphone 550.

A user enters instructional information, such as a telephone number, for example, by pushing the buttons of a keypad 520 or by voice activation using the microphone 550. The microprocessor 510 receives and processes the instructional information to perform the appropriate function, such as to dial the telephone number. Operational data may be retrieved from the Subscriber Identity Module (SIM) card 525 or the memory module 530 to perform the function. Furthermore, the processor 510 may display the instructional and operational information on the display 515 for the user's reference and convenience.

The processor 510 issues instructional information to the RF module 535, to initiate communication, for example, transmits radio signals comprising voice communication data. The RF module 535 comprises a receiver and a transmitter to receive and transmit radio signals. An antenna 540 facilitates the transmission and reception of radio signals. Upon receiving radio signals, the RF module 535 may forward and convert the signals to baseband frequency for processing by the processor 510. The processed signals would be transformed into audible or readable information outputted via the speaker 545, for example. The processor 510 also includes the protocols and functions necessary to perform the various processes described herein.

The aforementioned embodiments are achieved by combination of structural elements and features of the present invention in a predetermined fashion. Each of the structural elements or features should be considered selectively unless specified otherwise. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with other claims referring to the other claims other than the specific claims to constitute the embodiment or add new claims by means of amendment after the application is filed.

The embodiments of the present invention have been described based on data transmission and reception between a BS (or eNB) and a UE. A specific operation which has been described as being performed by the eNB (or BS) may be performed by an upper node of the BS (or eNB) as the case may be. In other words, it will be apparent that various operations performed for communication with the UE in the network which includes a plurality of network nodes along with the BS (or eNB) can be performed by the BS or network nodes other than the BS (or eNB). The BS may be replaced with terms such as fixed station, Node B, eNode B (eNB), and access point. Also, the term UE may be replaced with terms such as mobile station (MS) and mobile subscriber station (MSS).

The embodiments according to the present invention can be implemented by various means, for example, hardware, firmware, software, or combinations thereof. If the embodiment according to the present invention is implemented by hardware, the embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a module, a procedure, or a function, which performs functions or operations as described above. Software code may be stored in a memory unit and then may be driven by a processor. The memory unit may be located inside or outside the processor to transmit and receive data to and from the processor through various well known means.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The present invention can be applied to a method and an apparatuses for a proximity-based service, specifically, for cooperative discovery for the proximity-based service.

1. A method of performing a discovery procedure for a Proximity-based Service (ProSe) by a User Equipment (UE) in a cellular communication system, the method comprising:
scanning one or more Wireless Local Area Network Access Points (WLAN APs);
transmitting a scan result for the one or more WLAN APs to a cellular network entity; and
initiating the discovery procedure for the ProSe, if the discovery procedure for the ProSe is allowed by the cellular network entity as a response to the scan result.

2. The method of claim 1, wherein the cellular network entity includes a 3rd Generation Partner Project (3GPP) network entity.

3. The method of claim 2, wherein the 3GPP network entity includes an evolved Node B (eNB), a Mobility Management Entity (MME) or a ProSe controller.

4. The method of claim 1, wherein the scan result includes a list of identification information for detected WLAN APs, wherein the identification information includes at least one of a Service Set Identification (SSID), a Basic Service Set Identification (BSSID) and a Medium Access Control (MAC) address.

5. The method of claim 4, wherein the scan result further includes a list of signal strengths of the detected WLNA APs.

6. The method of claim 1, wherein the discovery procedure for the ProSe is allowed if the UE receives, from the cellular network entity, information indicating existence of another UE in proximity.

7. A method of performing a discovery procedure for a Proximity-based Service (ProSe) by a cellular network entity in a cellular communication system, the method comprising:
receiving a first scan result for one or more first Wireless Local Area Network Access Points (WLAN APs) from a first User Equipment (UE);
receiving a second scan result for one or more second WLAN APs from a second UE; and
if there is one or more common WLAN APs between the one or more first WLAN APs and the one or more second WLAN APs, allowing the discovery procedure for the ProSe to at least one of the first UE and the second UE.

8. The method of claim 7, wherein the cellular network entity includes a 3rd Generation Partner Project (3GPP) network entity.

9. The method of claim 8, wherein the 3GPP network entity includes an evolved Node B (eNB), a Mobility Management Entity (MME) or a ProSe controller.

10. The method of claim 7, wherein the first and second scan results include a list of identification information for detected WLAN APs, wherein the identification information includes at least one of a Service Set Identification (SSID), a Basic Service Set Identification (BSSID) and a Medium Access Control (MAC) address.

11. The method of claim 10, wherein the first and second scan results further include a list of signal strengths of the detected WLNAAPs.

12. The method of claim 7, wherein the allowing the discovery procedure for the ProSe includes transmitting information indicating existence of another UE in proximity.

13. A User Equipment (UE) configured to perform a discovery procedure for a Proximity-based Service (ProSe) in a wireless communication system, the UE comprising:
a radio frequency (RF) unit; and
a processor, wherein the processor is configured:
to scan one or more Wireless Local Area Network Access Points (WLAN APs),
to transmit a scan result for the one or more WLAN APs to a cellular network entity, and
to initiate the discovery procedure for the ProSe, if the discovery procedure for the ProSe is allowed by the cellular network entity as a response to the scan result.

14. The UE of claim 13, wherein the cellular network entity includes a 3rd Generation Partner Project (3GPP) network entity.

15. The UE of claim 14, wherein the 3GPP network entity includes an evolved Node B (eNB), a Mobility Management Entity (MME) or a ProSe controller.

16. The UE of claim 13, wherein the scan result includes a list of identification information for detected WLAN APs, wherein the identification information includes at least one of a Service Set Identification (SSID), a Basic Service Set Identification (BSSID) and a Medium Access Control (MAC) address.

17. The UE of claim 16, wherein the scan result further includes a list of signal strengths of the detected WLNA APs.

18. The UE of claim 13, wherein the discovery procedure for the ProSe is allowed if the UE receives, from the cellular network entity, information indicating existence of another UE in proximity.

19. A cellular network entity configured to perform a discovery procedure for a Proximity-based Service (ProSe) in a wireless communication system, the UE comprising:
a radio frequency (RF) unit; and
a processor, wherein the processor is configured:
to receive a first scan result for one or more first Wireless Local Area Network Access Points (WLAN APs) from a first User Equipment (UE),
to receive a second scan result for one or more second WLAN APs from a second UE, and
if there is one or more common WLAN APs between the one or more first WLAN APs and the one or more second WLAN APs, to allow the discovery procedure for the ProSe to at least one of the first UE and the second UE.

20. The cellular network entity of claim 19, wherein the cellular network entity includes a 3rd Generation Partner Project (3GPP) network entity.

21. The cellular network entity of claim 20, wherein the 3GPP network entity includes an evolved Node B (eNB), a Mobility Management Entity (MME) or a ProSe controller.

22. The cellular network entity of claim 19, wherein the first and second scan results include a list of identification information for detected WLAN APs, wherein the identification information includes at least one of a Service Set Identification (SSID), a Basic Service Set Identification (BSSID) and a Medium Access Control (MAC) address.

23. The cellular network entity of claim 22, wherein the first and second scan results further include a list of signal strengths of the detected WLNA APs.

24. The cellular network entity of claim 19, wherein the allowing the discovery procedure for the ProSe includes transmitting information indicating existence of another UE in proximity.
